(19) United States
(12) Patent Application Publication
(10) Pub. No.: US 2013/0338905 A1
(43) Pub. Date: Dec. 19, 2013

(54) METHOD AND DEVICE FOR CONTROLLING A SPARK IGNITION ENGINE IN THE AUTO-IGNITION OPERATING MODE

(71) Applicants: Axel Loeffler, Backnang (DE); Wolfgang Fischer, Gerlingen (DE); Roland Karrelmeyer, Bietigheim-Bissingen (DE); Gerald Graf, Gaertringen (DE)

(72) Inventors: Axel Loeffler, Backnang (DE); Wolfgang Fischer, Gerlingen (DE); Roland Karrelmeyer, Bietigheim-Bissingen (DE); Gerald Graf, Gaertringen (DE)

(21) Appl. No.: 13/885,926

(22) PCT Filed: Oct. 12, 2011
(86) PCT No.: PCT/EP2011/067810

§ 371 Date: Sep. 3, 2013

(30) Foreign Application Priority Data
Nov. 16, 2010 (DE) 10 2010 043 966.5

(51) Int. Cl. F02D 41/00

(52) U.S. Cl. CPC F02D 41/00
USPC 701/104

(57) ABSTRACT

A method for operating an internal combustion engine in HCCI mode, including: a) sensing a profile of a measured variable of a variable in a combustion chamber of a cylinder; b) identifying combustion feature(s) of a combustion event in a first combustion cycle based on the profile; c) modeling a first value of a state variable at a defined point in time after the first combustion cycle and before a second subsequent combustion cycle based on the identified combustion feature(s); d) determining desired target values of combustion feature(s) of a combustion event in the second subsequent combustion cycle; e) modeling a second value of the state variable at the defined point in time based on the target values; and f) applying control to the internal combustion engine starting at the defined point in time as a function of the first and the second value of the state variable.

### FIELD

The present invention relates to Otto-cycle engines, in particular to methods for operating Otto-cycle engines using a homogeneous charge compression ignition (HCCI) method, a homogeneous autoignition method.

### BACKGROUND INFORMATION

In accordance with new operating methods, Otto-cycle engines can be operated in certain operating regions using an HCCI method, which corresponds to a homogeneous autoignition method. The HCCI method is a lean-burn method whose goal is to achieve a significant (10 to 15%) reduction in fuel consumption in the New European Driving Cycle (NEDC). This is achieved, in the context of operation of the Otto-cycle engine using the HCCI method, by unthrottling the engine and by thermodynamically more favorable combustion. Although the downstream three-way catalytic converter does not operate to reduce nitrogen in lean operation, the intention is that raw pollutant emissions, in particular oxides of nitrogen, are not significantly increased.

Because Otto-cycle fuel and the compression ratio of a conventional Otto-cycle engine are designed so that autoignition (expressed usually as knocking) is avoided as much as possible, the thermal energy necessary for the HCCI method must be made available in some other manner. This can be done in various ways. On the one hand, by retaining or reaspirating hot residual gases that in normal mode are to be ejected through exhaust valves, hot gas can be held in the combustion chamber so that increased thermal energy is available therein. On the other hand, the fresh air delivered by the Otto-cycle engine can be heated up in this operating mode.

In the context of making thermal energy available by retaining or reaspirating hot internal residual gas, the possibility exists, especially in peripheral regions of an operating region in which provision is made for HCCI mode, of a spontaneously occurring instability that can lead to combustion misfires and/or to knocking combustion (which damages the engine). In addition, the HCCI method requires particular open- or closed-loop control because of the cycle-to-cycle coupling that otherwise does not occur in internal combustion engines with almost complete gas exchange. In the context of a retention of residual gas, cycle-to-cycle coupling, i.e., the influence of what occurs in one combustion cycle on a subsequent combustion cycle in a cylinder, can also cause destabilizing effects in terms of dynamics, e.g., during gas exchange or operating mode switchover.

To allow instabilities that occur at the peripheral regions of the HCCI operating region to be precluded even as components age and under greatly varying environmental conditions, either the operating region usable for HCCI mode would need to be greatly limited, or other kinds of measures would need to be taken with regard to open- or closed-loop control. For example, the torque dynamics could be greatly limited, although this puts severe limits on the drivability of the motor vehicle operated with the internal combustion engine.

Cycle-to-cycle coupling in the context of retention or reaspiration of residual gas results in a spontaneously occurring change in combustion locations in successive combustion cycles. This can be expressed, for example, as fluctuations in the peak pressure occurring during combustion.

Two effects are generally responsible for the change in combustion locations. On the one hand, upon opening of the exhaust valve, the combustion-chamber temperature is at a higher level in the context of a later combustion event, which results in higher thermal energy in the retained or reaspirated residual gas. Combustion thus occurs earlier in the subsequent cycle. In addition, incomplete combustion can cause a carryover of fuel to the next combustion cycle, and can result therein, in the context of the excess air (lean mode) that is usual for HCCI methods, in greater energy conversion upon combustion. These effects can result in a considerable variation in combustion location, which, in peripheral operating regions of the HCCI method, can trigger instabilities in terms of, for example, smoothness.

It is an object of the present invention to compensate for the effects occurring as a result of cycle-to-cycle coupling, in order to utilize the maximum operating region for HCCI mode.

### SUMMARY

According to a first aspect in accordance with the present invention, a method for operating an internal combustion engine in HCCI mode is provided. The method includes the following steps:
a) sensing a profile of a measured variable of a variable in a combustion chamber of a cylinder of the internal combustion engine;
b) identifying one or more combustion features of a combustion event in a first combustion cycle based on the measured profile of the measured variable;
c) determining or modeling a first value of a state variable at a defined point in time after the first combustion cycle and before a second subsequent combustion cycle based on the identified one or more combustion features;
d) determining desired target values of one or more combustion features of a combustion event in the second subsequent combustion cycle;
e) determining or modeling a second value of the state variable at the defined point in time based on the target values of the one or more combustion features of the second combustion cycle; and
f) applying control to the internal combustion engine starting at the defined point in time as a function of the first value of the state variable and of the second value of the state variable.

In accordance with the example method, by forward calculation based on one or more combustion features calculated from a profile of a measured variable of a variable in a combustion chamber of a cylinder of the internal combustion engine, and optionally from measured values and/or model values of further state variables, a first value of the state variable at the defined point in time is determined, for example with the aid of thermodynamic correlations. In addition, proceeding from desired combustion features of a combustion event of a subsequent combustion cycle, a second value of the state variable is identified by backward calculation to the defined point in time based on values of further state variables that are dependent on environmental conditions. The desired combustion features derive from the desire to have the combustion processes (in steady-state operation) proceed to the greatest extent possible in the same manner, e.g., as the same combustion features as in the first combustion cycle, so that no cycle-to-cycle fluctuations occur. A control variable is corrected as a function of the first value of the state variable and the second value of the state variable. The control variable can indicate, for example, the quantity of fuel delivered, the point in time for the injection of fuel, and/or the point in time at which the intake valve closes, so as thereby, for example, to increase or decrease the temperature.

By defining the injection time it is possible, for example, to compensate for the instability that occurs in the peripheral region of the operating region for HCCI mode. This makes it possible to use the entire operating region for HCCI mode, and furthermore means that no destabilizing effects occur even in dynamic operation.

According to alternative embodiments, the first value of the state variable at the defined point in time can be determined before or after the beginning of a subsequent injection of fuel into the cylinder based on the identified one or more combustion features.

Provision can further be made that control is applied to the internal combustion engine as a function of a deviation between the first value of the state variable and the second value of the state variable.

In particular, control can be applied to the internal combustion engine using one or more control variables, such that the target values of the one or more control variables can be adapted iteratively by executing step e) once or repeatedly as a function of a deviation between the first value of the state variable and the respectively identified second value of the state variable.

The one or more control variables can be an injection quantity and/or an injection time.

A cylinder pressure can furthermore be identified as a measured variable.

A heat profile of the combustion event in the cylinder can be identified from the profile of the cylinder pressure, the one or more combustion features being identified from the heat profile.

According to an embodiment, the one or more combustion features can correspond to a crankshaft angle position at a predefined proportion of a mass conversion and/or at a predefined proportion of an energy conversion.

The second value of the state variable at the defined point in time can furthermore be identified based on an indication of an opening angle of an intake valve and/or a closing angle of an intake valve.

Provision can be made that the first value of the state variable at the defined point in time is furthermore identified based on an indication of an opening angle of an exhaust valve and/or a closing angle of the exhaust valve.

According to a further aspect, an apparatus for operating an internal combustion engine in HCCI mode is provided, the apparatus being embodied to:
receive a profile of a measured variable of a variable in a combustion chamber of a cylinder of the internal combustion engine;
identify one or more combustion features of a combustion event in a first combustion cycle based on the measured profile of the measured variable;
identify or model a first value of a state variable at a defined point in time after the first combustion cycle and before a second subsequent combustion cycle based on the identified one or more combustion features;
determine target values for one or more combustion features of a combustion event in the second subsequent combustion cycle;
determine or model a second value of the state variable at the defined point in time based on the target values of the one or more combustion features of the second combustion cycle; and
apply control to the internal combustion engine starting at the defined point in time as a function of the first value of the state variable and of the second value of the state variable.

According to a further aspect, an engine system is provided. The engine system may include:
an internal combustion engine,
a sensor for sensing a profile of a measured variable of a variable in a combustion chamber of a cylinder of the internal combustion engine,
a control unit, for
   identifying one or more combustion features of a combustion event in a first combustion cycle based on the measured profile of the measured variable;
   identifying or modeling a first value of a state variable at a defined point in time after the first combustion cycle and before a second subsequent combustion cycle based on the identified one or more combustion features;
   determining target values for one or more combustion features of a combustion event in the second subsequent combustion cycle;
   determining or modeling a second value of the state variable at the defined point in time based on the target values of the one or more combustion features of the second combustion cycle; and
   applying control to the internal combustion engine starting at the defined point in time as a function of the first value of the state variable and of the second value of the state variable.

According to a further aspect, a computer program product is provided which contains a program code that executes the above method when it is executed on a data processing unit.

### BRIEF DESCRIPTION OF THE DRAWINGS

Preferred embodiments are explained in further detail below with reference to the figures.

FIG. 1 schematically depicts an engine system having an Otto-cycle engine.

FIGS. 2a to 2c are diagrams depicting cycle-to-cycle fluctuations that occur upon operation of the Otto-cycle engine in conventional HCCI mode.

FIGS. 3a to 3c are diagrams depicting the time profiles of the cylinder pressure, cylinder temperature, and gas mass components in the combustion chamber in steady-state HCCI mode in accordance with the example method according to the present invention.

FIG. 4 is a flow chart to illustrate an example method for operating the engine system of FIG. 1.

FIGS. 5a and 5b show a measured cylinder pressure profile and the energy release resulting therefrom, in the context of two successive combustion cycles.

### DETAILED DESCRIPTION OF EXAMPLE EMBODIMENTS

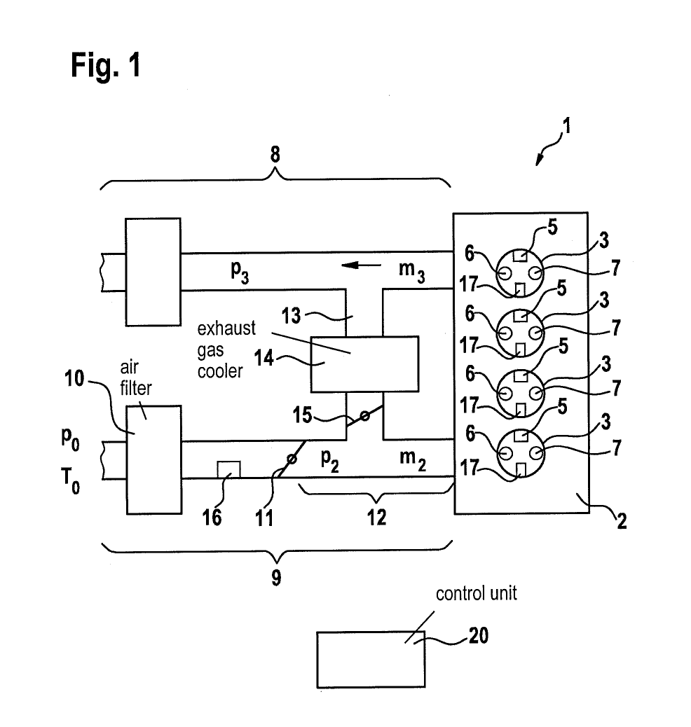

FIG. 1 schematically shows an engine system 1 having an internal combustion engine 2 that, in the present exemplifying embodiment, has four cylinders 3. The number of cylinders 3 is not limited to four, however, and in principle any desired number of cylinders 3 can be provided.

Internal combustion engine 2 is embodied as an Otto-cycle engine and has on each of the cylinders 3 injection valves 5 for direct injection of fuel.

Fresh air is delivered to cylinders 3 of internal combustion engine 2 via an air delivery section 9, and is admitted into cylinders 3 under the control of corresponding intake values 6. For this, the fresh air is aspirated from an environment of engine system 1 at an ambient air pressure p₀ and an ambient air temperature T₀, and guided via an air filter 10 into an intake duct section 12. Intake duct section 12 is located downstream from air filter 10, between a throttle valve 11 and intake valves 6 of internal combustion engine 2. An air mass sensor 16 is provided in air delivery section 9 upstream from throttle valve 11 in order to detect the quantity of air flowing in intake duct section 12.

Combustion exhaust gas produced after combustion in cylinders 3 is ejected via exhaust valves 7 into an exhaust discharge section 8. An exhaust gas recirculation conduit 13, which connects exhaust gas discharge section 8 to intake duct section 12, opens into intake duct section 12. A exhaust gas cooler 14 and an exhaust gas recirculation valve 15 are provided in exhaust gas recirculation conduit 13 in order to allow adjustment of the quantity and temperature of the recirculated exhaust gas. The state variables in intake duct section 12 are the intake duct pressure p₂ as well as the mass flow m₂ of the mixture of air and exhaust gas to be delivered to cylinders 3. An exhaust gas pressure p₃ and an exhaust gas mass flow m₃ exist in exhaust gas discharge section 8.

Internal combustion engine 2 is operated with the aid of a control unit 20. In order to operate internal combustion engine 2, control unit 20 controls actuators of engine system 1 such as, for example, throttle valve 11 for setting the quantity of air delivered to the cylinders, exhaust gas recirculation valve 15 for setting an exhaust gas recirculation rate that indicates the quantity of inert gas in the cylinders, inlet and exhaust valves 6, 7 and injection valves 5 for setting the point in time and duration of fuel injection. Operation of internal combustion engine 2 occurs on the basis of state variables that can be measured and/or at least in part modeled. State variables are, for example, the intake duct pressure p₂, the air mass flow m₀ that flows in intake duct section 12 and is detected by air mass sensor 16, the exhaust gas backpressure p₃, the rotation speed of internal combustion engine 2, and the torque of internal combustion engine 2.

Cylinders 2 are furthermore equipped with a cylinder pressure sensor 17 in order to sense an instantaneous cylinder pressure and furnish a corresponding indication to control unit 20.

In accordance with the present embodiment, control unit 20 operates internal combustion engine 2 in such a way that, in a specific operating region that can be predefined by the rotation speed and/or the torque and/or the intake duct pressure p₂, internal combustion engine 2 is operated in an HCCI mode, i.e., in an autoignition mode. In HCCI mode, which is assumed in particular with internal combustion engine 2 at partial load, internal combustion engine 2 is operated in such a way that a combustion event occurs with an excess of air, with self-ignition of the air-fuel mixture in the combustion chamber.

Provision is made for this purpose for operating internal combustion engine 2 in such a way that the combustion chamber temperature rises, during combustion chamber compression (compression stroke of the piston), in such a way that the ignition temperature of the air-fuel mixture is exceeded and autoignition occurs. Especially in peripheral regions of the operating region in which HCCI mode is to take place, fluctuations can occur as a result of a feedback effect. The feedback effect arises from the fact that a large quantity of hot residual gas from the previous combustion event is retained. If the temperature level of this is greatly different, the combustion location in the next cycle will be greatly different. If this retained residual gas furthermore contains uncombusted fuel components, an excess of air in the combustion chamber results in higher energy conversion at the subsequent combustion event.

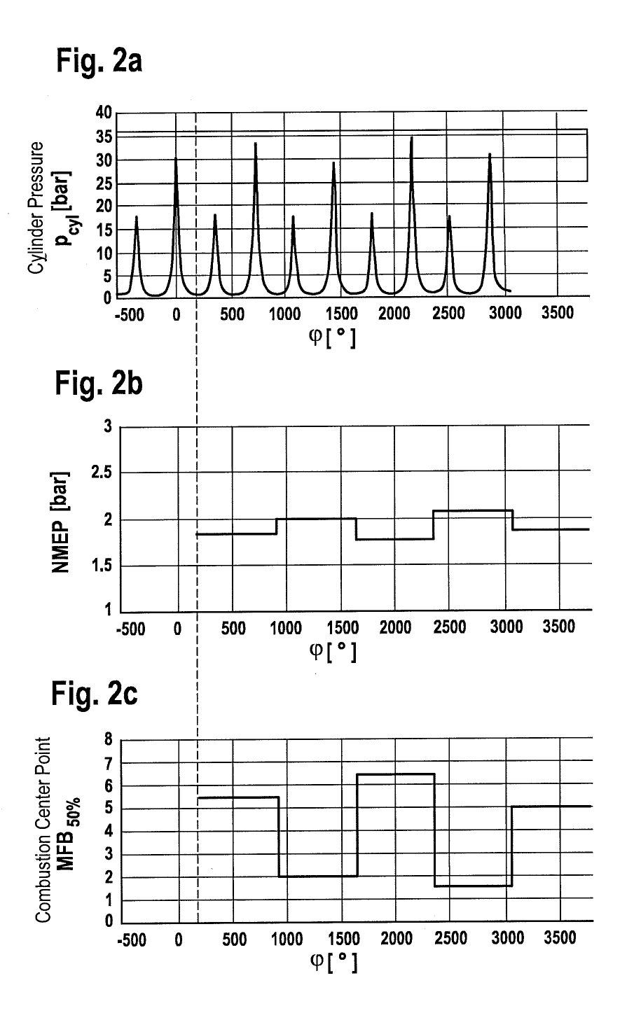

This effect is depicted, for example, in the diagram of FIG. 2a. It is apparent therein that the respective maximum pressure p_{cyl} during a combustion cycle fluctuates from cycle to cycle. These cycle-to-cycle fluctuations result in instabilities that can become apparent as knocking or misfires of the combustion event in the combustion chambers. To allow the maximum operating region for HCCI mode to be utilized, this cycle-to-cycle disruption must be compensated for so that the maximum pressure p_{cyl} of the combustion events (in steady-state engine operation) is approximately constant for successive combustion cycles. This can be achieved by implementing a closed-loop control method that is based on an adapted thermodynamic model of the combustion chamber.

In FIG. 2b, the feature NMEP is plotted against crankshaft angle. The feature NMEP (net mean effective pressure) represents an indication of the average induced work.

In FIG. 2c, the feature MFB50% is plotted against crankshaft angle. MFB50% corresponds to a combustion center point location (mean fraction burned) that is indicated as a crankshaft angle difference with respect to the crankshaft angle of the top dead center point.

Cycle-to-cycle coupling of the combustion cycles is brought about principally by the fact that complete gas exchange in the combustion chamber does not occur in HCCI mode, so that residual gas remaining in or aspirated back into the combustion chamber influences, because of its variable temperature, the next combustion event in HCCI mode.

The underlying differential equation for cylinder pressure is as follows:

$$\frac{d p}{d φ} = \frac{1}{V ( φ )} ⌊ ( k - 1 ) \cdot 〈 \frac{d H}{d φ} + \frac{d {Q}_{combust}}{d φ} + \frac{d {Q}_{DW}}{d φ} 〉 - k \cdot p \cdot \frac{d V}{d φ} ⌋ \qquad ( 1 )$$

where p indicates the cylinder pressure or combustion chamber pressure, φ the crankshaft angle, V the instantaneous cylinder volume as a function of crankshaft angle φ, which results kinematically from the geometry of the crank drive, K the instantaneous polytropic exponent that is dependent on the gas composition at the instantaneous temperature, dH the enthalpy flows associated with the mass flows through the valves (in the context of the intake and exhaust processes), and dQ_{combust} the energy release during combustion (also called “combustion profile”) and dQ_{DW} the wall heat losses. dQ_{combust} is also called the “combustion profile.”

The differential equation above can be derived by way of the principle of the conservation of energy and the ideal gas law. This is done in consideration of conditions in the container models, namely the pressure p, temperature T, and gas mass components of the substances involved. The gas mass components are grouped together for approximation. The gas mass components (air, residual gas, and fuel) react in a manner coupled to the phenomenologically modeled energy release rates at a stoichiometric ratio. In addition, the instantaneous combustion chamber temperature is identified via the ideal gas law as a derived variable, after identification of the pressure profile.

Restating equation (1) above yields a formula for the so-called heat profile, which corresponds to the combustion profile minus the wall heat loss, and which can be calculated on the basis of a measured cylinder pressure profile.

$$\frac{d {Q}_{heatprofile}}{d φ} = \frac{d {Q}_{combust}}{d φ} + \frac{d {Q}_{DW}}{d φ} + \frac{d H}{d φ} = \frac{1}{( k - 1 )} V ( φ ) \frac{d p}{d φ} + \frac{k}{( k - 1 )} p \frac{d V}{d φ} \qquad ( 2 )$$

It can be assumed in this context that no gas mass flows occur through the intake and exhaust valves during the combustion process (dH=0), and that κ can be considered constant or at least linearly dependent on the crankshaft angle φ. To improve accuracy, κ can be selected as a function of operating point.

Integrating equation (2) allows the features that characterize combustion to be extracted from the resulting integral heat profile Q(φ). The crankshaft angle φ at which combustion starts, or at which a specific proportion (x %) of the total energy conversion during the combustion cycle has occurred (mass conversion point), is of particular interest for the closed-loop control that is to be implemented. This crankshaft angle is called “start of combustion” (SOC) or MFBx % (mean fraction burned), where MFB10% indicates 10% mass conversion, MFB50% indicates the center point of the combustion event during the combustion cycle, and MFB90% indicates 90% mass conversion. The energy values Qx %=Q(MFBx %) pertaining to the crankshaft angle can also be used in the context of closed-loop control

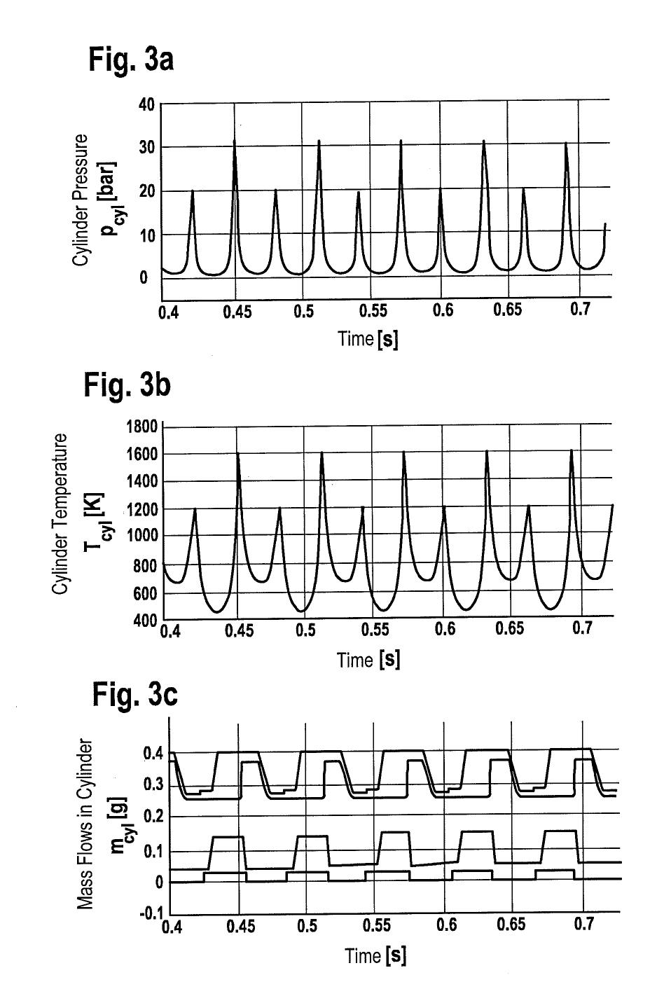

FIGS. 3a to 3b depict the time courses of the cylinder pressure p_{cyl}, cylinder temperature T_{cyl}, and gas mass component m_{cyl}. The time courses of the cylinder temperature T_{cyl} and gas mass component m_{cyl} in particular are not accessible, or accessible to only a very limited extent, via measurements based on currently available measurement technology.

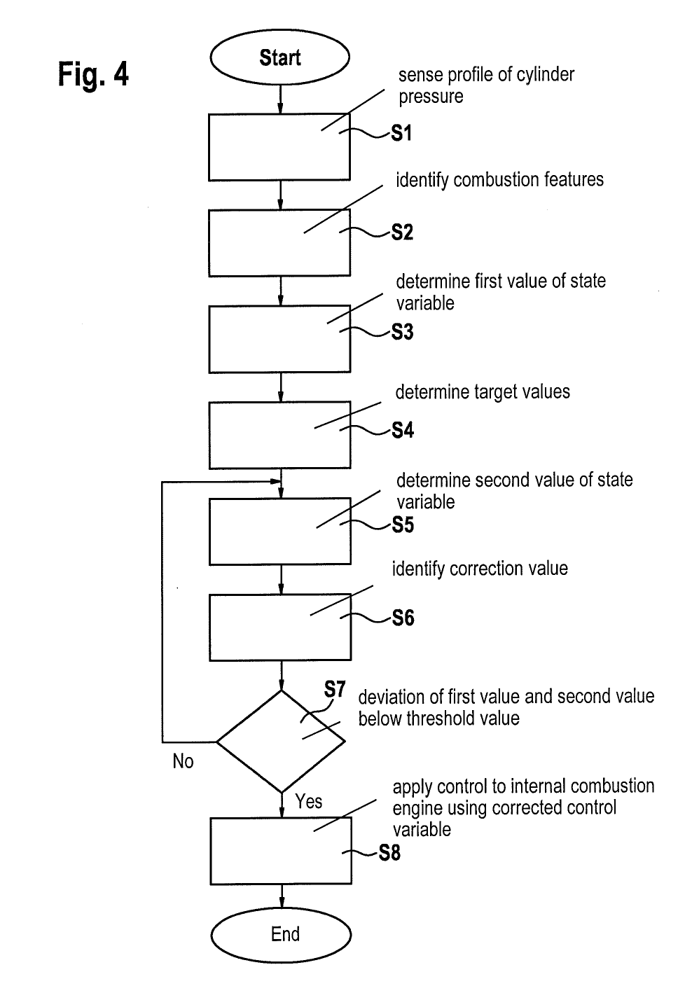

This information, or the difference between the actual values of these variables based on a measurement in a first ((k-1)-th) cycle and the desired target values in a subsequent second (k-th) cycle, will nevertheless be used below to calculate corresponding control actions. The method for identifying the application of control to the internal combustion engine will be described in further detail below with reference to the flow chart of FIG. 4.

In a first step S1, a profile of a cylinder pressure is sensed with the aid of cylinder pressure sensor 17 in a combustion chamber of one or more cylinders 3 of internal combustion engine 2. From the profile of the cylinder pressure, in step S2 one or more combustion features of a combustion event in a first combustion cycle that has just taken place is identified from the cylinder pressure profile based on the measured cylinder pressure profile. As described earlier, in step S3 a first value of a state variable at a defined point in time after the first combustion cycle, e.g., before a next injection of fuel into the cylinder begins, can be determined or modeled based on the identified one or more combustion features (e.g., SOC, MFB10%, MFB50%, MFB90%, Q10%, Q50%, Q90%). This has the advantage that the injection quantity for an immediately following combustion event can be adapted in accordance with the result of the method.

Alternatively, in step S3, the first value of the state variable at the defined point in time after the beginning of a next injection of fuel into the cylinder can be determined or modeled based on the identified one or more combustion features (e.g., SOC, MFB10%, MFB50%, MFB90%, Q10%, Q50%, Q90%). For example, the points in time at which the relevant intake valve opens or closes can be provided as suitable points in time for determining the first value of the state variable.

In addition, in step S4, target values are determined for one or more combustion features of a combustion event in a second combustion cycle following the first one. From this, in step S5, a second value of the state variable at the defined point in time is determined or modeled based on the one or more combustion features of the second combustion cycle. In step S6 at least one correction value for at least one control variable for applying control to internal combustion engine 2, e.g., an injection quantity or an injection time, is identified. If it is ascertained in step S7 that an indication of a deviation between the first and the second value is below a specific predefined threshold value (“Yes” alternative), control is then applied in step S8 to internal combustion engine 2 starting at the defined point in time using the at least one corrected control variable. Otherwise (“No” alternative) execution branches back to step S4 so that the modeling and identification of the second value of the state value is carried out again based on the at least one corrected control variable, until the indication of the deviation between the values of the state variables falls below the predefined threshold value.

To enhance the robustness of the thermodynamic model, the state in the cylinder at the beginning of the combustion cycle is estimated, and the model is initialized for the subsequent calculation using the estimated value.

Estimation of the cylinder state at the start of combustion is based on the autoignition temperature T_{IGN} of Otto-cycle fuel of approximately 1000° K., and on the point in time at which combustion starts (SOC), determined from the combustion chamber pressure signal. Together with the measured cylinder pressure at the start of combustion p(SOC), the gas constant R determined from a predefined mixture composition, and the cylinder volume V(SOC) calculated as a function of the start of combustion, the ideal gas law can be used to estimate the gas mass in cylinder 3 and thus the cylinder state.

$$pV = mRT$$

$$or$$

$$m = \frac{pV}{RT}$$

With this method, the start of combustion SOC can be determined from the measured combustion chamber pressure profile, e.g., using a conventional heat profile calculation. An elevated polytropic exponent of κ=1.4 is used for the heat profile calculation to ensure more-reliable determination of the start of combustion.

To enhance the accuracy of the estimation method, it is possible to use an iterative method, for example a Newtonian iterative method, in which the gas constant R is corrected as a function of the estimated cylinder state at start of combustion in cylinder 3, i.e., as a function of the mixture composition (air, fuel, and residual gas) resulting from the estimated cylinder mass. This is accomplished in particular by weighting the gas constants of the individual substances in accordance with their volumetric proportions in the air-fuel mixture that results in cylinder 3.

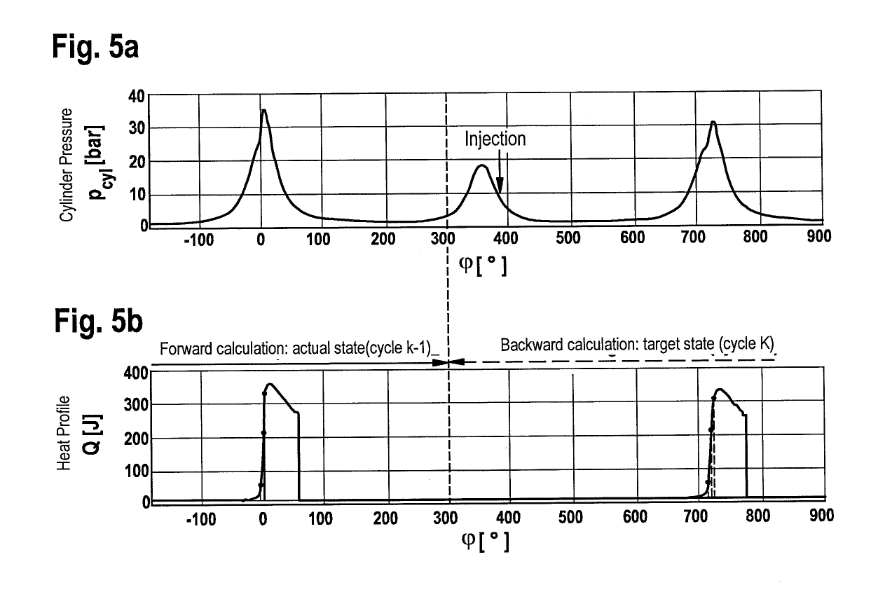

FIGS. 5a and 5b depict a measured cylinder pressure profile, and the energy release resulting therefrom yielding the heat profile dQ_{heatprofile} derived from equation (2), for two successive combustion cycles. The first combustion cycle is assumed as a given in this example, the states during the first combustion cycle representing the actual state. The subsequent second combustion cycle is intended to represent a target energy release Q.

The target energy release is characterized by one or more of the aforementioned features, e.g., SOC, MFB10%, MFB50%, and MFB90%, as well as Q10%, Q50%, and Q90%. Proceeding from the available actual combustion features, the values for the control variables (e.g., the opening and closing angle of the exhaust valves) known from the control system, and the estimated states in the cylinder at the start of combustion in the first combustion cycle, it is possible to calculate the states up to the beginning of an intermediate compression, the point in time of which corresponds to a predefined crankshaft angle before the start of combustion and is represented by the dashed line.

Conversely, proceeding from the available target combustion features, the target cylinder state derived therefrom at the start of combustion of the second cycle, and the values for control variables (e.g. the opening time and closing time of the intake valve) known from the control system, it is possible to calculate the states backward to the beginning of intermediate compression. Based on the difference in the state variables resulting from the forward calculation proceeding from the first cycle and the backward calculation proceeding from the second cycle, a correction of the control variables, namely the injection quantity and the point in time of injection, can then be performed.

This correction of the control variables can be performed on the basis of a difference between the first and the second value of the state variable, for example with the aid of a predefined function or a predefined characteristics diagram.

Adaptation/correction of the state variables can, for example, also occur iteratively, in which context an incremental correction of the injection time and/or injection quantity is performed, and a corresponding new backward calculation is again performed proceeding from the target state, until the difference in the state variables from the forward calculation proceeding from the first combustion cycle and from the backward calculation proceeding from the second combustion cycle falls below a predefined tolerance deviation.

Alternatively or additionally, combustion features derived from the state variables, e.g., the thermal energy at the beginning of intermediate combustion (or at another predefined reference point in time), can be employed as a starting point for calculating the injection corrections, i.e., the adaptation of the injection time and injection quantity.

While the above method has been explained with reference to steady-state engine operation, it is also analogously transferrable to dynamic operation, with the difference that the target values for the combustion features, as well as the pilot control values for the control variables, change in the context of the cycle-to-cycle dynamics, and this must accordingly be taken into account.

1-13. (canceled)

14. A method for operating an internal combustion engine in HCCI mode, comprising:
a) sensing a profile of a measured variable of a variable in a combustion chamber of a cylinder of the internal combustion engine;
b) identifying one or more combustion features of a combustion event in a first combustion cycle based on the profile of the measured variable;
c) determining a first value of a state variable at a defined point in time after the first combustion cycle and before a second subsequent combustion cycle, based on the identified one or more combustion features;
d) determining desired target values of one or more combustion features of a combustion event in the second subsequent combustion cycle;
e) determining a second value of the state variable at the defined point in time based on the target values of the one or more combustion features of the second combustion cycle; and
f) applying control to the internal combustion engine starting at the defined point in time as a function of the first value of the state variable and of the second value of the state variable.

15. The method as recited in claim 14, the first value of the state variable at the defined point in time being determined before or after the beginning of a subsequent injection of fuel into the cylinder based on the identified one or more combustion features.

16. The method as recited in claim 14, wherein the control is applied to the internal combustion engine as a function of a deviation between the first value of the state variable and the second value of the state variable.

17. The method as recited in claim 16, wherein the control is applied to the internal combustion engine using one or more control variables, the one or more control variables being adapted iteratively by executing step e) at least once as a function of a deviation between the first value of the state variable and the respectively identified second value of the state variable.

18. The method as recited in claim 17, wherein the one or more control variables include at least one of injection quantity and an injection time.

19. The method as recited in claim 14, wherein a cylinder pressure is a measured variable.

20. The method as recited in claim 19, wherein a heat profile of the combustion event in a cylinder is identified from a profile of the cylinder pressure, the one or more combustion features being identified from the heat profile.

21. The method as recited in claim 19, wherein the one or more combustion features include at least one of a crankshaft angle position at the start of combustion, at a predefined proportion of a mass conversion, and at a predefined proportion of an energy conversion.

22. The method as recited in claim 14, wherein the second value of the state variable at the defined point in time furthermore is identified based on an indication of at least one of an opening angle of an exhaust valve and a closing angle of an exhaust valve.

23. The method as recited in claim 14, wherein the first value of the state variable at the defined point in time furthermore being identified based on an indication of at least one of an opening angle of an exhaust valve and a closing angle of the exhaust valve.

24. An apparatus for operating an internal combustion engine in HCCI mode, the apparatus configured to:
receive a profile of a measured variable of a variable in a combustion chamber of a cylinder of the internal combustion engine;
identify one or more combustion features of a combustion event in a first combustion cycle based on the measured profile of the measured variable;
identify a first value of a state variable at a defined point in time after the first combustion cycle and before a second subsequent combustion cycle, based on the identified one or more combustion features;
determine target values of one or more combustion features of a combustion event in the second subsequent combustion cycle;
determine a second value of the state variable at the defined point in time based on the target values of the one or more combustion features of the second combustion cycle; and
apply control to the internal combustion engine starting at the defined point in time as a function of the first value of the state variable and of the second value of the state variable.

25. An engine system, comprising:
an internal combustion engine;
a sensor to sense a profile of a measured variable of a variable in a combustion chamber of a cylinder of the internal combustion engine; and
a control unit, configured to:
identify one or more combustion features of a combustion event in a first combustion cycle based on the profile of the measured variable;
identify a first value of a state variable at a defined point in time after the first combustion cycle and before a second subsequent combustion cycle, based on the identified one or more combustion features;
determine target values of one or more combustion features of a combustion event in the second subsequent combustion cycle;
determine a second value of the state variable at the defined point in time based on the target values of the one or more combustion features of the second combustion cycle; and
apply control to the internal combustion engine starting at the defined point in time as a function of the first value of the state variable and of the second value of the state variable.

26. A machine readable storage medium storing a program code that, when it is executed on a data processing unit, causes the data processing unit to perform the steps of:
a) sensing a profile of a measured variable of a variable in a combustion chamber of a cylinder of the internal combustion engine;
b) identifying one or more combustion features of a combustion event in a first combustion cycle based on the profile of the measured variable;
c) determining a first value of a state variable at a defined point in time after the first combustion cycle and before a second subsequent combustion cycle, based on the identified one or more combustion features;
d) determining desired target values of one or more combustion features of a combustion event in the second subsequent combustion cycle;
e) determining a second value of the state variable at the defined point in time based on the target values of the one or more combustion features of the second combustion cycle; and
f) applying control to the internal combustion engine starting at the defined point in time as a function of the first value of the state variable and of the second value of the state variable.
